(19) United States
(12) Patent Application Publication
(10) Pub. No.: US 2004/0239656 A1
(43) Pub. Date: Dec. 2, 2004

(54) Electro-optical device, method of driving the same, circuit for driving the same, and electronic apparatus

(75) Inventor: Katsunori Yamazaki, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/662,371

(22) Filed: Sep. 16, 2003

(30) Foreign Application Priority Data
Sep. 20, 2002 (JP) 2002-275197

(51) Int. Cl. G09G 5/00

(52) U.S. Cl. 345/204

(57) ABSTRACT

The invention provides an electro-optical device capable of suppressing cross talk without increasing power consumption or complicating the structure of a circuit, a method of driving the same, a circuit for driving the same, and an electronic apparatus. The invention can include a liquid crystal display device that includes a plurality of scanning lines and a plurality of data lines wired to cross the scanning lines. Further, the liquid crystal display device includes a dummy electrode wired to cross each data line and capacitive-coupled with each data line, an inversion logic circuit for comparing a voltage signal generated in the dummy electrode to a predetermined voltage to thus output the amount of change in the voltage signal, and logic circuits and for adding the amount of the change in the voltage signal output from the inversion logic circuit to the electric potential of a scanning signal supplied to each scanning line.

### BACKGROUND OF THE INVENTION

1. Field of Invention

The present invention relates to an electro-optical device, a method of driving the same, a circuit for driving the same, and an electronic apparatus.

2. Description of Related Art

Recently, electro-optical devices capable of displaying an image using an electro-optical change in an electro-optical material, such as liquid crystal, are widely used for various electronic apparatuses and television sets. Thus, it is possible to make television sets thin, small, and consume less power, which is not possible for television sets using conventional cathode ray tubes (CRT).

Various types of electro-optical devices are disclosed. But, most of them can be classified from each other on an appropriate basis. For example, a classification on the basis of a driving method is commonly performed. To be specific, electro-optical devices can be divided roughly into active matrix type electro-optical devices driving pixels by switching and passive matrix type electro-optical devices driving pixels without using switching elements. The former, active matrix type electro-optical devices, are divided roughly into electro-optical devices using 3-terminal type switching elements, such as thin film transistors (TFTs), and electro-optical devices using 2-terminal type switching elements, such as thin film diodes (TFDs), according to the kinds of switching elements.

FIG. 10 is an electric block circuit diagram of a main portion illustrating a liquid crystal display device as the electro-optical device using the 2-terminal type switching element such as the latter TFD. As illustrated in FIG. 10, the liquid crystal display device includes a plurality of scanning lines Y1 to Yn (n is an integer), a plurality of data lines X1 to Xm (m is an integer) crossing the plurality of scanning lines Y1 to Yn, and pixels 90 located corresponding to the portions where the scanning lines Y1 to Yn cross the data lines X1 to Xm. Each pixel 90 is represented by an equivalent circuit where a TFD 91 as a switching element and a liquid crystal capacitor 92 are serially connected to each other.

Further, the liquid crystal capacitor 92 includes a scanning line electrode and a data line electrode with liquid crystal layers used as a dielectric substance.

According to such a structure, scanning signals set as a selection voltage and a non-selection voltage corresponding to a selection period and a non-selection period are provided to each of the scanning lines Y1 to Yn. Further, data signals with pulse width modulated on the basis of display data (gray scales) are provided to each of the data lines X1 to Xm. Further, the pixels 90 are driven by the scanning signals (selection voltage) and the data signals.

### SUMMARY OF THE INVENTION

But, according to such a liquid crystal display device, when a voltage (a data signal) of the data lines X1 to Xm changes, the amount of change may overlap the voltage of the scanning lines Y1 to Yn as a noise voltage (distortion voltage) with a differential waveform. It will now be described with reference to an equivalent circuit related to the scanning lines Y1 to Yn of the liquid crystal display device illustrated in FIG. 11. In FIG. 11, the scanning lines Y1 to Yn have a resistance component 93 made of the output resistance of a scanning line driving circuit, the resistance of a guidance electrode connecting the output terminal of the scanning line driving circuit to each of the scanning lines Y1 to Yn, and the resistance of the electrodes itself of the scanning lines Y1 to Yn. Further, a capacitor component 94, which is a parasitic capacitor, is formed between the scanning lines Y1 to Yn and the data lines X1 to Xm in addition to the liquid crystal capacitor 92. By doing so, the equivalent circuit can be determined as a differential circuit consisting of the liquid crystal capacitor 92, the capacitor component 94, and the resistance component 93.

Therefore, when the voltage of the data lines X1 to Xm changes, the amount of change overlaps the voltage of the scanning lines Y1 to Yn as the noise voltage with the differential waveform. As illustrated in FIG. 11, for example, when the voltage of the data lines X1 to Xm changes to be in a step state by modulating the pulse width of the data signal, capacitor combination occurs through the liquid crystal capacitor 92. Therefore, the noise voltage in an impulse state overlaps the voltage of the scanning lines Y1 to Yn at the rising and falling timings.

When this noise voltage is applied to the scanning lines Y1 to Yn, the waveform of the selection voltage changes and the function of the TFD 91 as the switching element is also affected, to thus generate cross talk (horizontal cross talk) in an image. This is because the resistance value of the TFD 91 significantly changes due to an applied voltage unlike the TFT.

FIG. 12 is a view illustrating a display example of a liquid crystal display device of a normally-white display. Thereafter, the influences of such a noise voltage on the display will be described on the basis of FIG. 12. In FIG. 12, data signals are provided to data lines X1 to X (p−1) and data lines X (p+1) to Xm corresponding to a scanning line Yq so that the pixels 90 turn to white (degree of gray scales is 0%). Data signals are provided to the other portions so that the pixels 90 have a half tone of 50%.

At this time, as illustrated in FIG. 12, only the data signals provided to the data line Xp change in a horizontal scanning period H (a selection period) of the scanning line Yq. Therefore, since only the noise voltage corresponding to the change in the voltage of the data line Xp overlaps the scanning line Yp, the blunting of the rising of a difference signal between the scanning signals and the data signals driving the pixels 90 is reduced. Thus, almost ideal degree of gray scales is obtained.

On the other hand, in the horizontal scanning period H (the selection period) of the scanning lines except for the scanning line Yq, the data signals provided to all of the data lines X1 to Xm including the data line Xp simultaneously change. Therefore, the rising of the difference signal significantly blunts due to all of the noise voltages that overlap the scanning lines corresponding to the change in the voltage of the data lines X1 to Xm. Thus, the degree of the gray scales is reduced by the degree, which means that the gray scales turn white, and to which the rising of the difference signal blunts, compared to the ideal degree of gray scales, to thus generate the cross talk. Further, even if the degrees of blunting are the same, the higher an applied voltage is, the more severe the above-described influence can be.

In order to reduce the influence of this cross talk, for example, a time constant of the differential circuit may be reduced. To be specific, it is preferable to reduce the resistance component 93. However, such measurements have limitations in that increase in costs, which is accompanied by low resistance wiring lines, is inevitable.

For example, in Japanese Unexamined Patent Application Publication No. 10-39840, a method of correcting a driving voltage by a display pattern is disclosed. In this case, because a DAC is necessary, the structure of a circuit becomes complicated and other problem, such as power consumption and costs increase, are generated.

Therefore, a method of easily reducing the influence of the cross talk without making the structure of a circuit complicated is disclosed by the applicant in the Japanese Patent Application No. 2002-101177.

FIG. 13 is an electric block circuit diagram of a main portion illustrating the liquid crystal display device as the electro-optical device related to the disclosure. As illustrated in FIG. 13, in the liquid crystal display device, either the selection voltage with electric potential of ±VSEL or a holding voltage (not shown) with the electric potential of ±VSEL is provided to the scanning lines Y1 to Yn through a scanning line driving circuit 95.

The liquid crystal display device includes a dummy electrode 96 crossing the data lines X1 to Xm and capacitive-coupled with the data lines X1 to Xm in the panel thereof. A power source circuit 97 for providing a voltage for making a voltage applied to the dummy electrode always uniform is disposed in the dummy electrode 96. The power source circuit 97 consists of an operation amplification circuit 97a and a detection resistance 97b. A uniform voltage source (for example, a ground GND) and the dummy electrode 96 are connected to the non-inversion input terminal and the inversion input terminal of the operation amplification circuit 97a, respectively. Further, the detection resistance 97b with the resistance value equal to that of the resistance component 93 is inserted into between the output terminal of the operation amplification circuit 97a and the inversion input terminal of the operation amplification circuit 97a.

Further, the liquid crystal display device includes circuit configurations 98 and 99 for overlapping the amount of the change in the voltage output from the power source circuit 97 with the selection voltage of each electric potential.

The operation of the liquid crystal display device with such a structure will now be described. When the voltage of the data lines X1 to Xm changes, it is attempted to generate the noise voltage with the differential waveform in the dummy electrode 96 together with the scanning lines Y1 to Yn. But, since the dummy electrode 96 is connected to the inversion input terminal of the operation amplification circuit 97a constituting the power source circuit 97 and a uniform voltage source is connected to the non-inversion input terminal, the operation amplification circuit 97a outputs voltages such that the voltages of both input terminals are the same according to the circuit characteristic thereof.

Therefore, the noise voltage is not actually generated in the dummy electrode 96. That is, the amount of the change in the voltage output from the power source circuit 97 is provided to the dummy electrode 96 through the detection resistance 97b. As a result, the noise voltage is not actually generated in the dummy electrode 96.

Therefore, the noise voltage of the scanning lines Y1 to Yn is offset on the basis of the above by the circuits 98 and 99 providing new selection voltages that overlap the respective selection voltages by the same amount of the change in the voltage output from the power source circuit 97 to the scanning lines Y1 to Yn through the resistance component 93.

FIG. 14 is a time chart illustrating voltages of the scanning lines Y1 to Yn in the case where a noise voltage is corrected by such a liquid crystal display device and in the case where the noise voltage is not corrected by such a liquid crystal display device. In FIG. 14, when the data signal (the voltage) changes to be in the step state, the noise voltage in the state of the differential waveform overlaps the voltage of the scanning lines Y1 to Yn. On the other hand, a correction voltage, the amount of change in the voltage is output from the power source circuit 97. The correction voltage overlaps the voltage of the scanning lines Y1 to Yn through the circuit configurations 98 and 99. Therefore, the noise voltage that overlaps the voltage of the scanning lines Y1 to Yn is offset to thus reduce the influence of the cross talk.

But, even if such a structure is adopted, it is not still possible to solve the problems of the increase in power consumption, the complication of the operation amplification circuit 97a, and the increase in costs because it is necessary that the operation amplification circuit 97a that constitutes the power source circuit 97 operate at relatively high speed.

An object of the present invention is to provide an electro-optical device capable of suppressing the cross talk without increasing the power consumption and complicating the structure of a circuit, a method of driving the same, a circuit for driving the same, and an electronic apparatus.

In order to achieve the above object, there is provided an electro-optical device with a plurality of scanning lines and a plurality of data lines, which are wired to cross the scanning lines. The electro-optical device can include electrodes which are wired to cross the data lines and are capacitively coupled with the data lines, comparison circuits for comparing signal levels generated in the electrodes to a predetermined level to output the amount of change in the signal levels, and logic circuits for adding the amount of change in the signal levels output from the comparison circuits to the signal levels supplied to each scanning line.

The electro-optical device according to the present invention can include comparison circuits for comparing signal levels generated in the electrodes capacitively coupled with each data line to a predetermined level to output the amount of change in the signal levels. Therefore, the amount of the change in the signal level generated in the electrode according to the change in the data signal supplied to the data line is detected only by comparing the signal level to the predetermined level (by determining a threshold). That is, it is possible to obtain a relatively high-speed response without increasing the power consumption or complicating the structure of the circuit. The amount of the change in the signal level generated in the electrode corresponds to a noise component that overlaps each scanning line and is a factor of cross talk. Further, the amount of change in the signal level is added to the signal level supplied to each scanning line by logic circuits to thus compensate for the cross talk. Therefore, the cross talk is suppressed without increasing the power consumption and complicating the structure of the circuit.

Further, there is provided an electro-optical device with a plurality of scanning lines, a scanning line driving circuit for supplying to each of the scanning lines a scanning signal which is set to be at a selection level and a non-selection level corresponding to a selection period and a non-selection period of each scanning line, a plurality of data lines which is wired to cross the scanning lines, a data line driving circuit for supplying to each of the data lines a data signal whose pulse width is modulated on the basis of display data, and pixels provided in portions where the scanning lines cross the data lines and driven on the basis of the scanning signals and the data signals. The electro-optical device can include electrodes which are wired to cross the data lines and are capacitively coupled with the data lines, comparison circuits for comparing signal levels generated in the electrodes to a predetermined level to output the amount of change in the signal levels, and logic circuits for adding the amount of change in the signal levels output from the comparison circuits to the selection level.

The electro-optical device according to the present invention can include the comparison circuit for comparing the signal level generated in the electrode capacitive-coupled to each data line to the predetermined level to output the amount of the change in the signal level. Therefore, the amount of the change in the signal level generated in the electrode by the change in the data signal supplied to the data line is detected only by comparing the signal level to the predetermined level (by determining a threshold). That is, it is possible to obtain a relatively high-speed response without increasing the power consumption or complicating the structure of the circuit. The amount of the change in the signal level generated in the electrode corresponds to the noise component that overlaps each scanning line and is a factor of the cross talk. Further, the amount of the change in the signal level is added to the selection level by the logic circuit to thus compensate for the cross talk. Therefore, the cross talk is suppressed without increasing the power consumption and complicating the structure of the circuit.

The electro-optical device according to the present invention generally includes an electro-optical material whose state and whose optical characteristics change by applying an appropriate electric field through electrification in a scanning line and the data line.

Such an electro-optical material may be, more specifically, for example, the above-mentioned liquid crystal.

According to an aspect of the electro-optical device of the present invention, the comparison circuits are inversion logic circuits, in which a predetermined bias level is applied to input terminals. According to this aspect, the comparison circuits are inversion logic circuits with an extremely simple and easy structure, in which a predetermined bias level is applied to input terminals.

According to another aspect of the electro-optical device of the present invention, the logic circuits do not add the amount of change in the signal levels output from the comparison circuits to the selection level at an early stage of the selection period. According to this aspect, since the amount of the change in the signal level is not added to the selection level at the early stage of the selection period, the cross talk is not compensated for before and after the selection period.

There is provided a method of driving an electro-optical device with a plurality of scanning lines, a scanning line driving circuit for supplying to each of the scanning lines a scanning signal which is set to be at a selection level and a non-selection level corresponding to a selection period and a non-selection period of each scanning line, a plurality of data lines which is wired to cross the scanning lines, a data line driving circuit for supplying to each of the data lines a data signal whose pulse width is modulated on the basis of display data, and pixels provided in portions where the scanning lines cross the data lines and driven on the basis of the scanning signals and the data signals. The method can include the steps of wiring electrodes to cross the data lines and capacitively coupling the electrode with the data lines, comparing a signal level generated in the electrode to a predetermined level to output the amount of change in the signal level, and adding the amount of change in the signal level to the selection level.

According to the method of driving the electro-optical device of the present invention, the signal level generated in the electrode capacitively coupled to each data line is compared to the predetermined level to output the amount of the change in the signal level. Therefore, the amount of the change in the signal level generated in the electrode by the change in the data signal supplied to the data line is detected only by comparing the signal level to the predetermined level (by determining a threshold).

That is, it is possible to obtain a relatively high-speed response without increasing the power consumption or complicating the structure of the circuit. The amount of the change in the signal level generated in the electrode corresponds to the noise component that overlaps each scanning line and is a factor of the cross talk. Further, the amount of the change in the signal level is added to the selection level to compensate for the cross talk.

Therefore, the cross talk is suppressed without increasing the power consumption or complicating the structure of the circuit.

There is provided a circuit for driving an electro-optical device of the present invention with a plurality of scanning lines, a scanning line driving circuit for supplying to each of the scanning lines a scanning signal which is set to be at a selection level and a non-selection level corresponding to a selection period and a non-selection period of each scanning line, a plurality of data lines which is wired to cross the scanning lines, a data line driving circuit for supplying to each of the data lines a data signal whose pulse width is modulated on the basis of display data, and pixels provided in portions where the scanning lines cross the data lines and driven on the basis of the scanning signals and the data signals. The circuit can include electrodes which are wired to cross the data lines and are capacitively coupled with the data lines. The circuit compares signal levels generated in the electrodes to a predetermined level to output the amount of change in the signal levels. The circuit adds the amount of the change in the signal levels to the selection level.

According to the driving circuit of the electro-optical device of the present invention, the amount of the change in the signal level is output by comparing the signal level generated in the electrode capacitive-coupled with each data line to a predetermined level. Therefore, the amount of the change in the signal level generated in the electrode by the change in the data signal supplied to the data line is detected only by comparing the signal level to the predetermined level (by determining a threshold).

That is, it is possible to obtain a relatively high-speed response without increasing the power consumption or complicating the structure of the circuit. The amount of the change in the signal level generated in this electrode corresponds to the noise component that overlaps each scanning line and is a factor of the cross talk. Further, the amount of the change in the signal level is added to the selection level to compensate for the cross talk. Therefore, the cross talk is suppressed without increasing the power consumption or complicating the structure of the circuit.

An electronic apparatus according to the present invention comprises the above-mentioned electro-optical device (including various aspects) according to the present invention. According to the electronic apparatus of the present invention, it is possible to realize an image display, in which the cross talk is suppressed without increasing the power consumption or complicating the structure of the circuit.

### BRIEF DESCRIPTION OF THE DRAWINGS

The invention will be described with reference to the accompanying drawings, wherein like numerals reference like elements, and wherein:

FIG. 1 is a block diagram illustrating the electric structure of an electro-optical device according to the present invention;

FIG. 2 is a time chart illustrating the respective signals in the case where cross talk is generated;

FIG. 3 is a time chart illustrating the waveform examples of the respective signals in a four-valued driving method;

FIG. 4 is a time chart illustrating the waveform example of a data signal suitable for a control signal;

FIG. 5 is a circuit diagram illustrating an inversion logic circuit;

FIG. 6 is a view illustrating the properties of a TFD;

FIG. 7 is a time chart illustrating the waveform examples of the respective signals in the case of displaying a half tone;

FIG. 8 is a perspective view illustrating a personal computer that is an example of an electronic apparatus;

FIG. 9 is a perspective view illustrating a mobile phone that is an example of the electronic apparatus;

FIG. 10 is a block diagram illustrating the electric structure of a conventional electro-optical device;

FIG. 11 is an equivalent circuit diagram related to each scanning line of a liquid crystal display device;

FIG. 12 is a view explaining a cross talk phenomenon;

FIG. 13 is a block diagram illustrating the electric structure of another conventional electro-optical device; and

FIG. 14 is a graph illustrating a result of measuring the cross talk of the conventional electro-optical device.

### DETAILED DESCRIPTION OF PREFERRED EMBODIMENTS

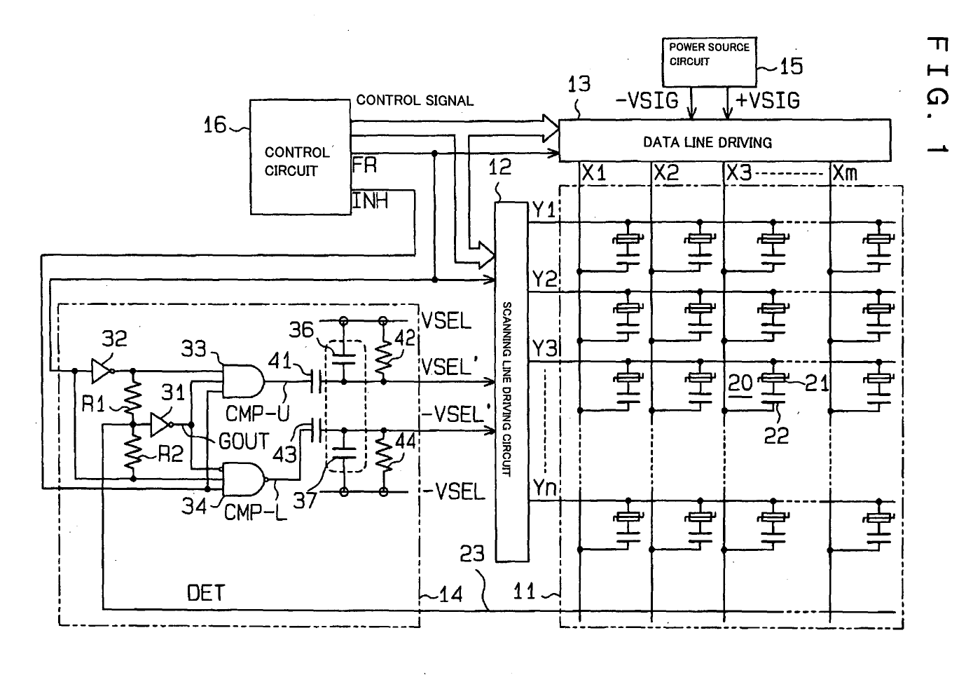

An embodiment, in which an electro-optical device according to the present invention is applied to a liquid crystal display device will now be described with reference to the drawings. FIG. 1 is an exemplary block diagram illustrating the electric structure of the liquid crystal display device according to the present embodiment. As illustrated in FIG. 1, the liquid crystal display device can include a liquid crystal panel 11, a scanning line driving circuit 12, a data line driving circuit 13, a power source circuit 14 for supplying to the scanning line driving circuit 12a voltage with a later-mentioned electric potential ±VSEL′, a power source circuit 15 for supplying to the data line driving circuit 13 voltage with an electric potential +VSIG, and a control circuit 16.

The liquid crystal panel 11 includes a plurality of scanning lines Y1 to Yn (n is an integer) and a plurality of data lines X1 to Xm (m is an integer) that cross the scanning lines Y1 to Yn. Further, one end of each of scanning lines Y1 to Yn and one end of each of data lines X1 to Xm are connected to the scanning line driving circuit 12 and the data line driving circuit 13, respectively.

Further, the liquid crystal panel 11 can include pixels 20 disposed correspondingly in the portions where the scanning lines Y1 to Yn cross the data lines X1 to Xm. Each pixel 20 is represented by an equivalent circuit, in which a TFD (thin film diode) 21 as a switching element and a liquid crystal capacitor 22 are serially connected to each other. The TFD 21 has, for example, the current-voltage property illustrated in FIG. 6. When a voltage is around a zero voltage, current hardly flows. However, when the absolute value of a voltage is larger than that of a threshold voltage Vth, current rapidly increases with the increase in the voltage. Further, the liquid crystal capacitor 22 consists of the electrodes of the scanning lines Y1 to Yn and the electrodes of the data lines X1 to Xm with a liquid crystal layer used as a dielectric substance.

Further, the liquid crystal panel 11 can include a dummy electrode 23, which is wired to cross each of the data lines X1 to Xm and is capacitive-coupied with each of the data lines X1 to Xm. The dummy electrode 23 is arranged to be adjacent to the scanning line Yn.

The scanning line driving circuit 12 supplies scanning signals VY1 to VYn with a level, in which an electric potential is either ±VSEL′ or ±VHLD, to each of the scanning lines Y1 to Yn. The level of each of the scanning signals VY1 to VYn is converted into ±VSEL′ and ±VHLD respectively in accordance with the selection period and the non-selection period (holding period) of each of the scanning lines Y1 to Yn. Further, the selection period of each scanning line is a horizontal scanning period of a corresponding scanning line.

The data line driving circuit 13 supplies data signals VX1 to VXm with a level, in which an electric potential is ±VSIG, to each of the data lines X1 to Xm. The level of each data signal VX1 to VXm is converted at timing suitable for the gray scale degree of each pixel 20.

The power source circuit 14 is connected to the scanning line driving circuit 12, the control circuit 16, and the dummy electrode 23. A voltage with an electric potential ±VSEL is applied to the power source circuit. The power source circuit 14 detects a change in the voltage of the dummy electrode 23 on the basis of a control signal from the control circuit 16 and corrects the electric potential ±VSEL of an applied voltage on the basis of the detected voltage. Further, the power source circuit 14 supplies a voltage with the corrected electric potentials ±VSEL′ and ±VHLD (not shown) to the scanning line driving circuit 12.

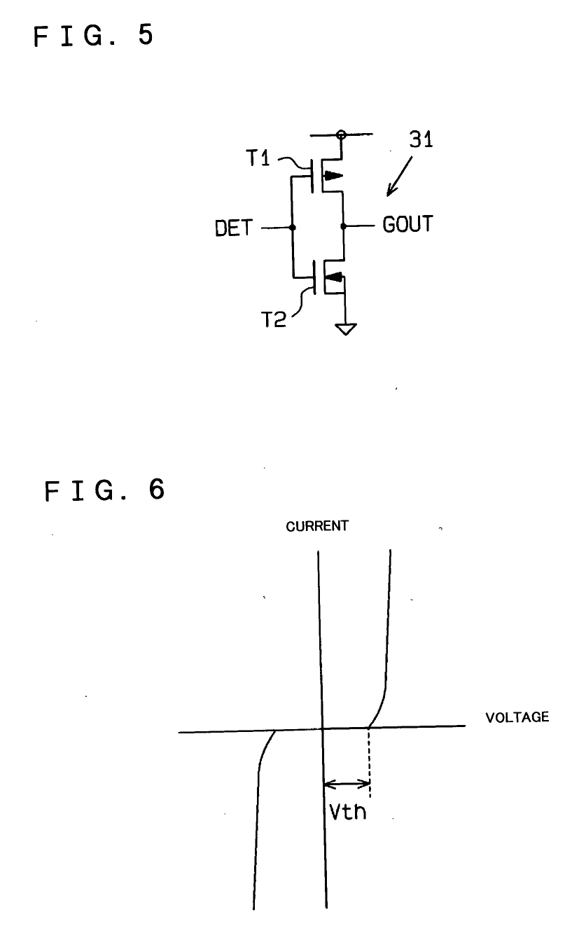

In detail, the power source circuit 14 includes an inversion logic circuit 31 as a comparison circuit whose input terminal is connected to the dummy electrode 23. As illustrated in FIG. 5, the inversion logic circuit 31 has a structure, in which, for example, a P channel MOS transistor T1 and an N channel MOS transistor T2 are serially connected to each other. The input terminal of the inversion logic circuit 31 is connected to the connection terminals of resistors R1 and R2 (R1<R2). Further, the other ends of the resistors R1 and R2 are connected to the output terminal and the input terminal of an inversion logic circuit 32, respectively. A polarity indication signal FR from the control circuit 16 is input to the input terminal of the inversion logic circuit 32. The input terminal of the inversion logic circuit 31 is biased to a predetermined voltage that is a divided voltage of the resistors R1 and R2 suitable for the polarity of the polarity indication signal FR. As described below, the polarity indication signal FR defines the recording polarity of the data signal.

Further, the output terminals of the inversion logic circuits 31 and 32 are connected to two input terminals, respectively, among the three input terminals of a first logic circuit 33 as a logic circuit. An inhibit signal INH from the control circuit 16 is input to the remaining input terminal of the first logic circuit 33. The first logic circuit 33 outputs an H level signal in the case where the output signals from the inversion logic circuits 31 and 32 and the inhibit signal INH are all at an H level (a high electric potential) and an L level signal in the other cases from the output terminal thereof.

Further, the output terminal of the inversion logic circuit 31 is connected to the inversion input terminal of a second logic circuit 34 as a logic circuit. The polarity indication signal FR from the control circuit 16 and the inhibit signal INH are input to the other two input terminals of the second logic circuit 34. The second logic circuit 34 outputs the L level signal in the case where the output signal from the inversion logic circuit 31 is at the L level and the polarity indication signal FR and the inhibit signal INH are all at the H level and the H level signal in the other cases from the inversion output terminal thereof.

The output terminal of the first logic circuit 33 is connected to a differential circuit that consists of a capacitor 41 and a resistor 42. The inversion output terminal of the second logic circuit 34 is connected to a differential circuit that consists of a capacitor 43 and a resistor 44. Further, an output signal CMP-U from the first logic circuit 33 and an output signal CMP-L from the second logic circuit 34 are added to a plus electric potential +VSEL and a minus electric potential −VSEL, respectively, as differential signals. Thus, the electric potential +VSEL and the electric potential −VSEL are corrected as an electric potential +VSEL′ and an electric potential −VSEL′.

The power supply circuit 14 supplies the voltage corrected as mentioned above with the electric potential ±VSEL′ to the scanning line driving circuit 12.

Further, gain controlling capacitors 36 and 37 are disposed in the power source circuit 14. The gain controlling capacitors control the amplitudes of the output signals CMP-U and CMP-L, respectively, by dividing capacity when the amplitudes of the output signals CMP-U and CMP-L are too large. The capacitors 36 and 37 are not essential, but the amplitudes may be controlled by, for example, dividing resistance instead of the capacitors 36 and 37.

The control circuit 16 outputs various control signals to the scanning line driving circuit 12, the data line driving circuit 13, and the power source circuit 14. In particular, the control circuit 16 outputs display data corresponding to the gray scale degree of each pixel 20 to the data line driving circuit 13.

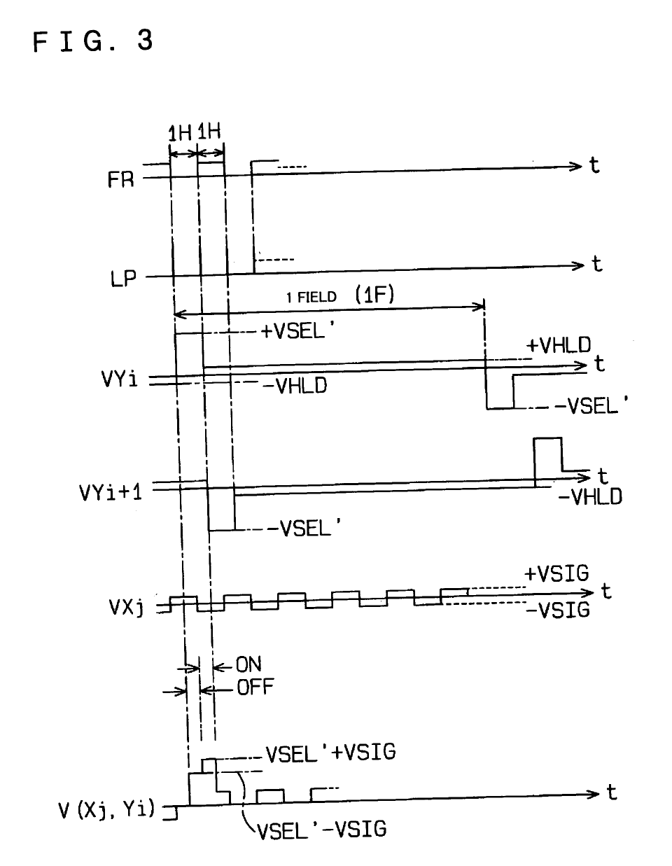

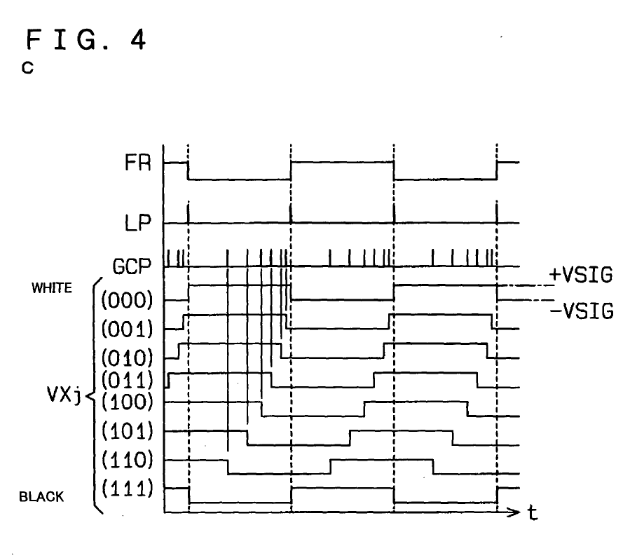

Next, the operation of the liquid crystal display device with such a circuit structure will now be described on the basis of the time charts of FIGS. 3 and 4. According to the present embodiment, it is assumed that a four-valued driving method (1 H selection and 1 H inversion) is adopted as a method of driving the liquid crystal display device. Therefore, the operation corresponding to the method will be described after basically describing the four-valued driving method (1 H selection and 1 H inversion).

Various methods of driving the liquid crystal display device other than the above method (such as for example, a four-valued driving method (1 H selection and ½ H inversion)) may be adopted.

FIG. 3 is a time chart illustrating examples of waveforms of the polarity indication signal FR, a scanning period definition signal LP, a scanning signal VYi applied to a scanning line Yi of an i row (i is an integer satisfying 1≦i≦n), a data signal VXj applied to a data line Xj of a j column (j is an integer satisfying 1≦j≦m), and a voltage V (Xj, Yi) applied to the pixel 20 of the i row and j column in the four-valued driving method (1 H selection and 1 H inversion). FIG. 4 is a time chart illustrating examples of waveforms of the polarity indication signal FR, the scanning period definition signal LP, a gray scale definition signal GCP for defining gray scales, and a data signal VXj corresponding to each gray scale (the gray scale definition signal GCP).

In FIG. 3, since the scanning period definition signal LP defines a horizontal scanning period 1H with predetermined time width, the polarity indication signal FR is inverted in synchronization with the scanning period definition signal LP. The polarity indication signal FR defines the recording polarity of the data signal and is input to the scanning line driving circuit 12 and the data line driving circuit 13 rather than the control circuit 16.

The scanning line driving circuit 12 supplies a selection voltage, in which the electric potential of the scanning signal VYi becomes +VSEL′ as a selection level, to the scanning line Yi in the selection period when the L level polarity indication signal FR is input. Further, when the non-selection period (the holding period) of the corresponding scanning line Yi has come, the scanning line driving circuit 12 supplies a non-selection voltage (a holding voltage), in which the electric potential of the scanning signal VYi becomes +VHLD as a non-selection level, to the scanning line Yi. Further a period, in which all of the scanning lines Y1 to Yn are selected and terminated, is referred to as a field period F (one vertical scanning period). The scanning line driving circuit 12 repeatedly supplies the selection voltage, in which the electric potential of the scanning signal VYi becomes −VSEL′ as a selection level, in this selection period and the non-selection voltage (the holding voltage), in which the electric potential of the scanning signal VYi becomes −VHLD as the non-selection level, in the non-selection period when one field period has lapsed from the selection of a previous time of the corresponding scanning line Yi. Further, the scanning line driving circuit 12 supplies a selection voltage, in which the electric potential of the scanning signal VYi+1 becomes −VSEL′, to the next scanning line Yi+1 in the selection period when the H level polarity indication signal FR is input. Further, when the non-selection period of the corresponding scanning line Yi+1 has come, the scanning line driving circuit 12 supplies the non-selection voltage (the holding voltage), in which the electric potential of the scanning signal VYi+1 becomes −VHLD, to the scanning line Yi+1. Thus, the reason why the scanning signal is inverted in the order of the selected scanning line Yi is to prevent the generation of flicker.

On the other hand, display data from the control circuit 16 and the gray scale definition signal GCP are input together to the data line driving circuit 13. The display data is input to each data line Xj (the pixel 20) connected to the selected scanning line Yi, for example, three-bit data (spq) (s, p and q are 0 or 1). According to the present embodiment, driving in a normally-white mode is adopted. Therefore, a white color is displayed for display data (000) and a black color is displayed for display data (111). Gray scales change step by step so that it becomes dark in the order of these display data (000) to (111).

As illustrated in FIG. 4, the gray scale definition signal GCP rises at the timing where one horizontal scanning period (1H) is divided into seven. The data line driving circuit 13 supplies a voltage, in which the electric potential of the data signal VXj becomes +VSIG, excluding a case corresponding to the display data (111) when the L level polarity indication signal FR is input. Further, the data line driving circuit 13 makes the electric potential of the data signal VXj corresponding to the display data (110), the electric potential of the data signal VXj corresponding to the display data (101), . . . , and the electric potential of the data signal VXj corresponding to the display data (001)−VSIG in the order whenever the rising of the gray scale definition signal GCP is input. Further, the data line driving circuit 13 supplies a voltage, in which the electric potential of the data signal VXj becomes −VSIG, through the selection period in a case corresponding to the display data (111) when the L level polarity indication signal FR is input. In the case of corresponding to the display data (000), the electric potential of the data signal VXj becomes −VSIG by the next gray scale definition signal GCP. However, since the scanning period definition signal LP is previously input and the selection period of the next scanning line Yi+1 comes, the selection period of the scanning line Yi is terminated with the electric potential remaining as +VSIG. The above is established in a case where the L level polarity indication signal FR is input. In the case where the H level polarity indication signal FR is input, the reverse relationship is established. Specifically, in FIG. 4, it is assumed that the order is reversed such that (000), (001), . . . , and (111) are arranged in the order from the bottom.

The data line driving circuit 13 supplies the data signal VXj, in which the polarity of an electric potential changes in accordance with this display data (spq) and the gray scale definition signal GCP, to each data line Xj.

In general, when each time width until the polarity of the data signal VXj changes is determined as one unit and an aspect of applying a voltage, in which an electric potential becomes ±VSIG, to the one unit is accepted as an application of a pulse signal, the data signal VXj is pulse width-modulated in accordance with the display data.

Here, the voltage applied to each pixel 20 has a value obtained by subtracting the electric potential of the corresponding data line Xj from the electric potential of the corresponding scanning line Yi. In FIG. 3, the selection period of the corresponding scanning line Yi is divided into an interval, in which the electric potential of the data signal VXj becomes +VSIG, and an interval, in which the electric potential of the data signal VXj becomes −VSIG. In the former interval (an off interval), the electric potential of the voltage V (Xj, Yi) applied to the corresponding pixel 20 becomes +VSEL′ and −VSIG. In the latter interval (an on interval), the electric potential of the voltage V (Xj, Yi) becomes +VSEL′ and +VSIG.

The selection period of a scanning line Yi+1 with a reverse polarity is also divided into an interval, in which the electric potential of the data signal VXj becomes −VSIG, and an interval, in which the electric potential of the data signal VXj becomes +VSIG, on the basis of the above. At this time, in the former interval (the off interval), the electric potential of the voltage V (Xj, Yi+1) applied to the corresponding pixel 20 becomes −VSEL′ and +VSIG. In the latter interval (the on interval), the electric potential of the voltage V (Xj, Yi) becomes −VSEL′ and −VSIG.

In the voltage V (Xj, Yi), the electric potentials ±VSEL′(±VSEL) and ±VSIG are set so that the absolute value [VSEL′ and −VSIG] is less than the threshold voltage Vth of the TFD 21 and that the absolute value [VSEL′ and +VSIG] is more than the threshold voltage Vth. Therefore, the longer the on interval is (in the order of (000), (001), . . . , and (111) in FIG. 4), the higher the value of the effective voltage applied to the liquid crystal capacitor 22 is. Further, the value of the effective voltage changes step by step to thus change the light transmittance of the liquid crystal step by step. Therefore, it is possible to perform display in a half tone in the pixel 20. That is, the higher the gray scale to be given to the pixel 20 is (the darker the gray scale in the normally-white mode is), the timing, at which the electric potential of the data signal VXj is converted, is set so that the ratio occupied by the on interval is larger. Further, the polarity is based on a predetermined electric potential (for example, 0 V or the other electric potentials). To inverse the polarity means to convert a plus electric potential into a minus electric potential on the basis of the predetermined electric potential (or to convert the electric potential reverse).

Further, the above is established in a case where driving in the normally-white mode is adopted. In the case where driving in a normally-black mode is adopted, the reverse relationship is established. That is, the timing, at which the electric potential of the data signal VXj is converted, is set such that the higher (the brighter) the gray scale to be given to the pixel 20 is, the larger the ratio occupied by the on interval is.

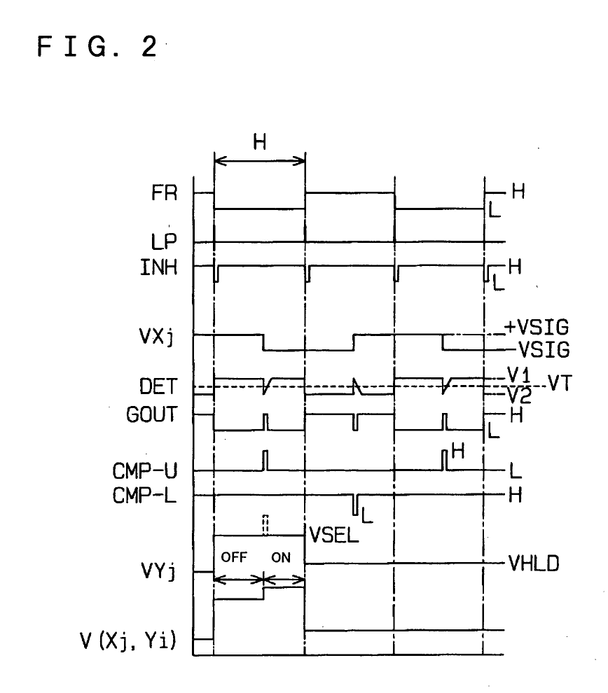

Next, the operation of compensating for the aforementioned cross talk will now be described. FIG. 2 is a time chart illustrating examples of the waveforms of the polarity indication signal FR, the scanning period definition signal LP, the inhibit signal INH, the gray scale definition signal GCP, the data signal VXj corresponding to a predetermined gray scale (here, corresponding to the display data (101)), a voltage signal DET for forming a signal level generated in the dummy electrode 23, an output signal GOUT of the inversion logic circuit 31, the output signals CMP-U and CMP-L of the first and second logic circuits 33 and 34, the scanning signal VYi, and the voltage V (Xj, Yi).

The inhibit signal INH is transited from the H level to the L level in a predetermined period in synchronization with the scanning period definition signal LP. The predetermined period is a short enough period for the scanning period 1H.

The connection terminals of the resistors R1 and R2, in which the other ends are connected to the output terminal and the input terminal of the inversion logic circuit 32, are connected to the dummy electrode 23. The polarity indication signal FR is input to the inversion logic circuit 32. Therefore, the voltage signal DET is basically transited to the divided voltage of the resistors R1 and R2 that form a bias level suitable for the polarity of the polarity indication signal FR. That is, when the L level polarity indication signal FR is input, the voltage signal DET becomes a voltage V1 obtained by multiplying R2/(R1+R2) by the magnitude of a voltage between the polarities of the polarity indication signal FR. On the other hand, when the H level polarity indication signal FR is input, the voltage signal DET becomes a voltage V2 obtained by multiplying R1(R1+R2) by the magnitude of the voltage between the polarities of the polarity indication signal FR. Further, because R1<R2, V1<V2.

While the L level polarity indication signal FR is input, when the data signal VXj changes (falls) to be in a step state by modulating pulse width, a noise voltage (a distortion voltage) in an impulse state overlaps the dummy electrode 23 (the voltage signal DET) at falling timing. On the other hand, while the H level polarity indication signal FR is input, the data signal VXj changes (rises) to be in the step state by modulating the pulse width, the noise voltage in the impulse state overlaps the dummy electrode 23 (the voltage signal DET) at rising timing.

The inversion logic circuit 31 outputs a result of comparing the voltage signal DET to a predetermined voltage VT for forming a predetermined level almost in the middle of the voltages V1 and V2 and outputs an output signal GOUT that is at the L level when the voltage signal is larger than the predetermined voltage VT and is at the H level when the voltage signal is less than the predetermined voltage VT. For example, while the L level polarity indication signal FR is input, when the noise voltage in the impulse state overlaps the dummy electrode 23, a signal component that is at the H level by the reversal of the magnitude relationship accompanied by the falling is generated in the output signal GOUT. Similarly, while the H level polarity indication signal FR is input, when the noise voltage in the impulse state overlaps the dummy electrode 23, a signal component that is at the L level by the reversal of the magnitude accompanied by the rising is generated in the output signal GOUT.

The output signal (the inversion signal of the polarity indication signal FR) of the inversion logic circuit 32, the output signal GOUT of the inversion logic circuit 31, and the inhibit signal INH are input to the first logic circuit 33. Therefore, the output signal CMP-U of the first logic circuit 33 is at the H level when all of the above signals are at the H level and is at the L level in the other cases. That is, the output signal CMP-U of the first logic circuit 33 is at the H level corresponding to the noise voltage in the impulse state, which overlaps the dummy electrode 23, while the L level polarity indication signal FR is input. The electric potential VSEL of the selection voltage is corrected by the output signal CMP-U of the first logic circuit 33 corresponding to the noise voltage to thus become the electric potential VSEL′. That is, the electric potential of the selection voltage is corrected to deny the cross talk. Further, the noise voltage overlaps in synchronization with the falling of the data signal VXj in the scanning signal VYi in the selection period. However, the noise voltage is offset by the same noise voltage at the rising described by a broken line generated corresponding to the output signal CMP-U. As a result, the scanning signal VYi in the selection period is shaped by a waveform described by a solid line. Further, the blunting of the rising of the voltage V (Xj, Yi) is also suppressed.

Regardless of the presence of the noise voltage, the output signal CMP-U is at the L level due to the inhibit signal INH that is at the L level in synchronization with the scanning period definition signal LP. This is for adding no correction before and after the selection period.

On the other hand, the output signal GOUT of the inversion logic circuit 31, the polarity indication signal FR, and the inhibit signal INH are input to the second logic circuit 34. Therefore, the output signal CMP-L of the second logic circuit 34 is at the L level when the output signal GOUT is at the L level and the polarity indication signal FR and the inhibit signal INH are at the H level, and is at the H level in the other cases. That is, the output signal CMP-L of the second logic circuit 34 is at the L level corresponding to the noise voltage in the impulse state, which overlaps the dummy electrode 23 while the H level polarity indication signal FR is input. The electric potential −VSEL of the selection voltage is corrected to be the electric potential −VSEL′ by the output signal CMP-L of the second logic circuit 34 corresponding to the noise voltage. That is, the electric potential of the selection voltage is corrected to deny the cross talk to thus operate like in the above.

Regardless of the presence of the noise voltage, the output signal CMP-L is at the H level due to the inhibit signal INH that is at the L level in synchronization with the scanning period definition signal LP. This is for adding no correction before and after the selection period.

As mentioned above, like in all of the scanning signals VY1 to VYn, the cross talk is compensated for to thus dissolve display spot caused by the cross talk by dissolving the noise voltage.

Here, in the voltage waveforms of the data signal VXj corresponding to the white and black colors, since polarities are inverted in synchronization with the scanning period definition signal LP, distortion is offset. Manners of generating the distortion are the same in a case where both the white color and the black color exist a lot and in a case where the white color does not exist and the black color exists little. Thus, it is difficult to correct the electric potential of the selection voltage. Therefore, starting time where the selection voltage is actually applied may be delayed for the scanning period definition signal LP.

Therefore, it is possible to prevent the influence of the distortion caused by the data signal VXj corresponding to the white and black colors. In particular, it is more effective to delay the starting time together with the prevention of correction before and after the selection period due to the inhibit signal INH.

As mentioned above, according to the present embodiment, the following effects are obtained.

According to the present embodiment, the amount of change in the voltage signal DET, which is generated in the dummy electrode 23 due to a change in the data signal supplied to the data line, can be detected only by comparing the voltage signal to the predetermined voltage VT (by determining a threshold). That is, it is possible to make a relatively high-speed response without increasing power consumption or complicating the structure of a circuit. The amount of the change in the voltage signal DET, which is generated in the dummy electrode 23, is added to the electric potential of the selection voltage by the first and second logic circuits 33 and 34 to thus compensate for the cross talk. Therefore, it is possible to suppress the cross talk without increasing the power consumption or complicating the structure of the circuit.

According to the present embodiment, the inversion logic circuit 31 as a comparison circuit is formed to have an extremely simple and easy structure, in which a predetermined bias level is applied to input terminals.

According to the present embodiment, the amount of change in the voltage signal DET at an early stage of the selection period is not added to the electric potential of the selection voltage. Therefore, it is possible to prevent the compensation of the cross talk before and after the selection period. Therefore, it is possible to prevent the correction of the electric potential of the selection voltage at the white color (with the gray scale degree of 0%) and the black color (with the gray scale degree of 100%).

An example of using the electro-optical devices according to the above-mentioned embodiment for electronic apparatuses will now be described. Such electro-optical devices can be applied to various electronic apparatuses, such as mobile type computers, mobile phones, digital still cameras, projection type display devices, liquid crystal TV sets, electronic organizers, word processors, view finder type or monitor direct-view type video tape recorders, workstations, videophones, POS terminals, and touch panels. According to these electronic apparatuses, it is possible to display images, in which the cross talk is suppressed without increasing the power consumption or complicating the structure of the circuit.

First, an example of applying the above-mentioned electro-optical device to the display portion of a personal computer will now be described. FIG. 8 is a perspective view illustrating the structure of the personal computer. In FIG. 8, a computer 60 includes a main body 62 with a keyboard 61 and a display device 63, in which a liquid crystal display device (a liquid crystal panel 11) is used as the display portion. Further, in the case where a transmission type liquid crystal display device is used as the display device 63, a back light (not shown) is disposed on the back surface to secure visibility in a dark place.

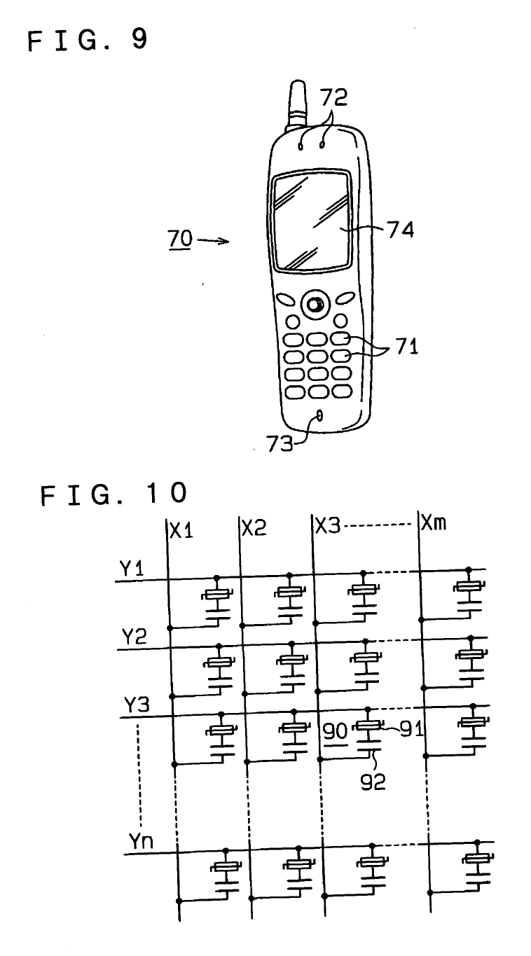

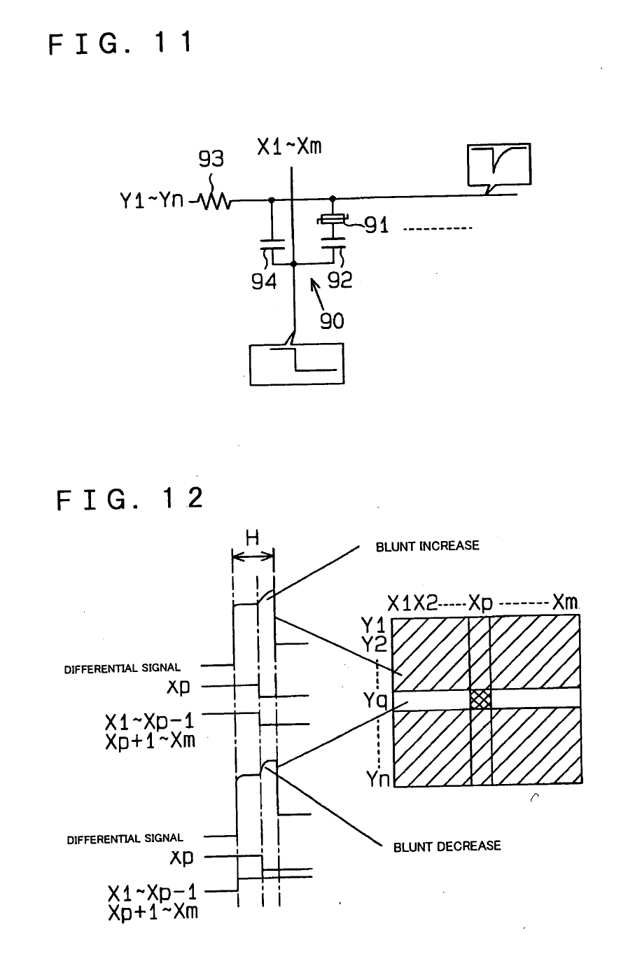

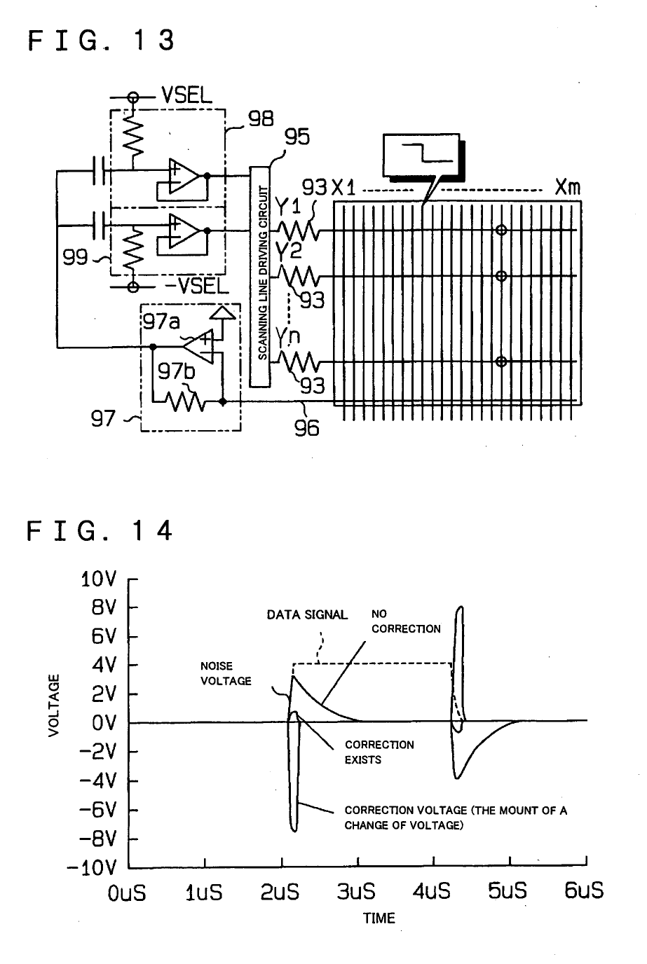

An example of applying the above-mentioned electro-optical device is applied to the display portion of a mobile phone will now be described. FIG. 9 is a perspective view illustrating the structure of the mobile phone. In FIG. 9, a mobile phone 70 includes a plurality of manipulation buttons 71, an earpiece 72, a mouthpiece 73, and a display device 74 using the above-mentioned electro-optical display device. In the case of using the liquid crystal display device (the liquid crystal panel 11) as the display device 74, in order to secure visibility in a dark place, when a transmission type liquid crystal display device or a half-transmission and half-reflective type liquid crystal display device is used, a back light is provided. When a reflective type liquid crystal display device is used, a front light (not shown) is provided.

It should be understood that the present invention is not limited to the above-mentioned embodiment. For example, various modifications may be made as follows.

According to the above embodiments, first, the off interval is set in the selection period of each scanning line and then, the on interval is set (see FIG. 2). Thus, a method of setting the off interval in advance is referred to as right adjustment driving. To the contrary, a method of setting the on interval in advance and then, setting the off interval is referred to as left adjustment driving. In the above embodiment, it is needless to say that the left adjustment driving may be performed.

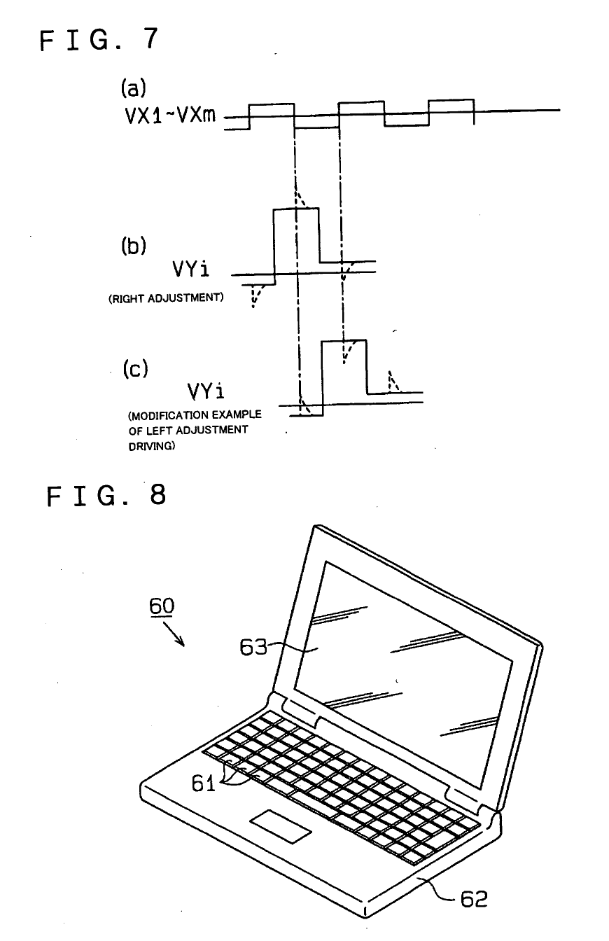

Here, the waveforms of the scanning signal VYi in the cases of performing the right adjustment driving and the left adjustment driving are illustrated in FIG. 7, respectively. The actual waveforms appearing at the scanning line Yi in the cases of the right adjustment driving and the left adjustment driving are identical with each other. However, the selection voltage with the electric potential ±VSEL, which is indicated by a broken line, is actually applied to the scanning line driving circuit 12. Therefore, in the case of adopting the right adjustment driving, the withstand voltage of the scanning line driving circuit 12 must be larger than ±VSEL. On the other hand, in the case of adopting the left adjustment driving, the withstand voltage of the scanning line driving circuit 12 is enough as long as the withstand voltage corresponding to ±VSEL is secured. Therefore, in the case of adopting the left adjustment driving, it is possible to reduce the withstand voltage of the circuit.

According to the above embodiment, the voltage signal DET is obtained through the dummy electrode 23 that is not used for displaying images. In place of that, it is possible to connect the power source circuit 14 to one scanning line that is not selected among the scanning lines Y1 to Yn and to compensate for the cross talk generated in other scanning lines due to the voltage signal DET generated in the scanning line. For example, it is preferable that the scanning lines Y1 and Yn corresponding to the upper and lower ends of a screen be alternately used every ½ frame instead of the dummy electrode 23.

According to the above embodiment, each of the elements 11 to 16 may consist of independent electronic parts. For example, each of the elements 12 to 16 may consist of a semiconductor integrated circuit of one chip. Further, all or some of the elements 11 to 16 may consist of integrated electronic parts. For example, the scanning line driving circuit 12 and the data line driving circuit 13 may be integrated with the liquid crystal panel 11.

According to the embodiment, an example of applying the present invention to the TFD type liquid crystal display device is described. However, the present invention is not limited to the TFD type liquid crystal display device. For example, it is needless to say that the present invention can be applied to electro-optical devices with a plurality of scanning lines and a plurality of data lines which is wired to cross the scanning lines, in which various electro-optical elements using electrophoresis devices, electroluminescenses (EL), digital micro mirror devices (DMD), or fluorescence caused by plasma light emission or electron emission are used and among them, to various electro-optical devices in which the cross talk may be generated and electronic apparatuses with the electro-optical devices.

While this invention has been described in conjunction with specific embodiments thereof, it is evident than many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. An electro-optical device including a plurality of scanning lines and a plurality of data lines which are wired to cross the scanning lines, comprising:
electrodes which are wired to cross the data lines and are capacitively coupled with the data lines;
comparison circuits that compare signal levels generated in the electrodes to a predetermined level to output an amount of change in the signal levels; and
logic circuits that add the amount of change in the signal levels output from the comparison circuits to the signal levels supplied to each scanning line.

2. An electro-optical device including:
a plurality of scanning lines;
a scanning line driving circuit that supplies to each of the scanning lines a scanning signal which is set to be at a selection level and a non-selection level corresponding to a selection period and a non-selection period of each scanning line;
a plurality of data lines which are wired to cross the scanning lines;
a data line driving circuit that supplies to each of the data lines a data signal whose pulse width is modulated on the basis of display data; and
pixels provided in portions where the scanning lines cross the data lines and driven on the basis of the scanning signals and the data signals,
the electro-optical device comprising:
electrodes which are wired to cross the data lines and are capacitively coupled with the data lines;
comparison circuits that compare signal levels generated in the electrodes to a predetermined level to output an amount of change in the signal levels; and
logic circuits that add the amount of change in the signal levels output from the comparison circuits to the selection level.

3. The electro-optical device according to claim 1, the comparison circuits being inversion logic circuits, in which a predetermined bias level is applied to input terminals.

4. The electro-optical device according to claim 2, the logic circuits not adding the amount of change in the signal levels output from the comparison circuits at an early state of the selection period to the selection level.

5. A method of driving an electro-optical device including a plurality of scanning lines, a scanning line driving circuit that supplies to each of the scanning lines a scanning signal which is set to be at a selection level and a non-selection level corresponding to a selection period and a non-selection period of each scanning line, a plurality of data lines which are wired to cross the scanning lines, a data line driving circuit that supplies to each of the data lines a data signal whose pulse width is modulated on the basis of display data, and pixels provided in portions where the scanning lines cross the data lines and driven on the basis of the scanning signals and the data signals, the method comprising:
wiring electrodes to cross the data lines and capacitively coupling the electrodes with the data lines;
comparing signal levels generated in the electrodes to a predetermined level to output an amount of change in the signal levels; and
adding the amount of change in the signal levels to the selection level.

6. A circuit for driving an electro-optical device including:
a plurality of scanning lines;
a scanning line driving circuit that supplies to each of the scanning lines a scanning signal which are set to be at a selection level and a non-selection level corresponding to a selection period and a non-selection period of each scanning line;
a plurality of data lines which are wired to cross the scanning lines;
a data line driving circuit that supplies to each of the data lines a data signal whose pulse width is modulated on the basis of display data, and pixels provided in portions where the scanning lines cross the data lines and driven on the basis of the scanning signals and the data signals,
the circuit comprising electrodes which are wired to cross the data lines and are capacitively coupled with the data lines,
the circuit comparing signal levels generated in the electrodes to a predetermined level to output the amount of change in the signal levels, and
the circuit adding an amount of change in the signal levels to the selection level.

7. An electronic apparatus, comprising the electro-optical device according to claim 1.
